(19) United States
(12) Patent Application Publication
(10) Pub. No.: US 2013/0124258 A1
(43) Pub. Date: May 16, 2013

(54) Methods and Systems for Identifying Customer Status for Developing Customer Retention and Loyality Strategies

(71) Applicants: Zainab Jamal, Palo Alto, CA (US); Hsiu-Khuern Tang, San Jose, CA (US)

(72) Inventors: Zainab Jamal, Palo Alto, CA (US); Hsiu-Khuern Tang, San Jose, CA (US)

(21) Appl. No.: 13/581,603

(22) PCT Filed: Mar. 8, 2010
(86) PCT No.: PCT/US10/26488

§ 371 Date: Sep. 20, 2012

(51) Int. Cl. G06Q 30/02

(52) U.S. Cl. CPC G06Q 30/0201
USPC 705/7.29

(57) ABSTRACT

Embodiments of the present invention are directed to methods and systems for developing customer retention and loyalty strategies. In one aspect, a method comprises calculating (202) likelihoods of next action taken by customers, based on customer attributes and associated attribute weights stored in a customer data base, and calculating (203) customer churn-risk scores, based on customer attributes that vary over time using the computing device. The methods also determines (207) what-if-scenarios for each customer based on churn-risk scores in order to identify the next-best-action to reduce probability of customer churn, and determines (208) when-to-act time thresholds for each customer based on churn-risk scores in order to identify when a non-high risk customer of churning will likely become a high-risk customer of churning at some later time. The method also selects (209) customer retention and loyalty strategies for customers, based on the churn-risk scores, what-if-scenarios, and when-to-act time thresholds.

### BACKGROUND

Computers are being exploited increasingly to enable commerce between firms (e.g., businesses) and their customers. For example, many customer transactions are performed via communication with one or more websites of a firm. In any event, since customers often are identified uniquely in computer-logged activities, customer transactions with a firm can be stored as data for analysis. The activities of individual customers can be mined to provide information about customer behavior.

Customers can engage in commerce with a firm in a contractual or non-contractual setting. In a contractual setting, the firm may provide goods/services under an agreement that is maintained and/or renewed explicitly or implicitly over time and that is terminated expressly. For example, the firm may provide cable television service to customers via a monthly contract that can be terminated by each customer at the end of any month. As another example, the firm may be a bank that provides banking services to account holders that entrust the bank with their money and that remain customers as long as some of the money remains with the bank. Accordingly, commerce performed in a contractual setting allows a firm to observe when customers become inactive, which is referred to as customer “churning.” Thus, a firm in a contractual setting can identify its active customer base with accuracy. In contrast, in a non-contractual setting, a firm may provide goods/services on demand, without any agreement about whether or not a customer will remain active with the firm.

Distinguishing active customers from inactive ones in a non-contractual setting can be problematic. Customers that are still active, but have not exhibited recent activity, cannot be distinguished unambiguously from those that have churned. Thus, in a non-contractual setting, customers often are deemed as active or inactive based on an approach using an arbitrary measure of activity, such as whether or not a customer has performed a transaction with the firm within a given period of time, such as one year. However, this approach is inaccurate and reactive, instead of proactive.

### BRIEF DESCRIPTION OF THE DRAWINGS

FIG. 1 shows a system for evaluating a likelihood of next action by customers in a non-contractual setting in accordance with one or more embodiments of the present invention.

FIG. 2 shows a flowchart illustrating steps of an example method for identifying customer status and for developing customer retention and customer loyalty programs in accordance with one or more embodiments of the present invention.

FIG. 3 shows a flowchart illustrating steps that may be performed in an example method of preparing customer data referenced in a step of the flowchart shown in FIG. 2 in accordance with one or more embodiments of the present invention.

FIG. 4 shows a flowchart illustrating steps in an example method of evaluating a likelihood of next action by customers in a non-contractual setting in accordance with embodiments of the present invention.

FIG. 5 shows a schematic representation of a computing device configured in accordance with embodiments of the present invention.

### DETAILED DESCRIPTION

The systems and methods disclosed herein may permit a film to identify customer current and future status for developing retention and loyalty stratagies at the individual customer level in a non-contractual setting. A customer's status relates to whether the customer is active (“alive”) or inactive (“dead” or “churned”). The customers that are active may still be using the firm's products and/or services and thus have potential future value to the firm. In contrast, churned customers interacted with the firm in the past but may have chosen to use the goods and/or services of a competitor of the firm, or may have left the industry altogether, among others. In some cases, a churned customer may bring negative value to the firm through negative comments or flagging the firm's communications as spam. In any event, by assessing the status of its customers, the firm may work more effectively to improve customer retention. The ability to retain a customer adds tremendous value to the firm. For example, reducing churn rate by one percent may add, on average, about five percent to the firm's value. The ability to predict the status of customers now (current status) and also predict their status in any given time window into the future (future status) may be of tremendous value to the firm as it enables the firm to implement retention and loyalty strategies that are proactive instead of reactive. Furthermore, estimating weights of different customer attributes as drivers of customer action and customer churn provide additional insights into which attributes are the key drivers of customer experience and which of the firm's processes and systems need to be improved to ensure an enhanced customer experience.

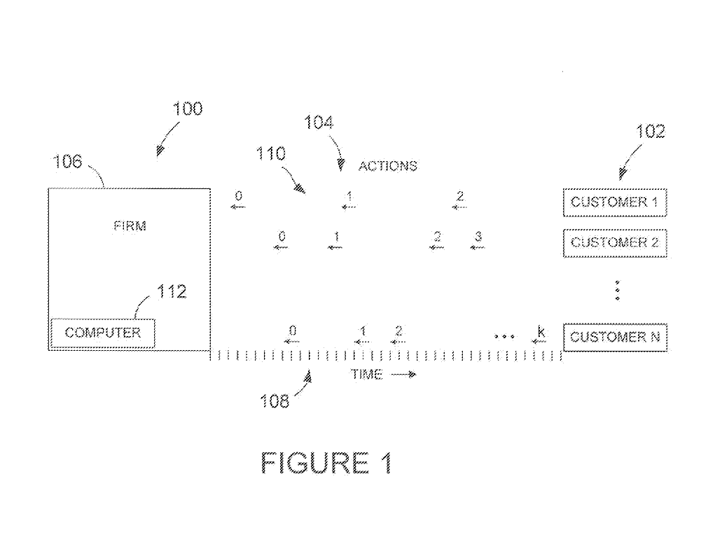

FIG. 1 shows a system 100 for evaluating a likelihood of next action by customers 102 in a non-contractual setting. Customer actions 104 performed with a firm 106 are represented with respect to time 108, to provide customer data 110. Each action for a given customer is numbered sequentially according to the order of action occurrence, starting at zero, which may represent registration of the customer with the firm. A customer may perform any number of actions over a total observation period, such as zero (registration only), one, two (e.g., Customer 1), three (e.g., Customer 2), or more (e.g., Customer N). Also, the actions of each customer may occur independently in time from actions of other customers. The firm may include at least one computer 112 or a computer network) that logs, stores, and/or receives data about customer actions 104, such as the time (e.g., the date and/or time of day) when each action occurred, the type of each action, a time interval between consecutive actions, and the like. Computer 112 also may calculate, store, and/or receive data regarding customer-specific attributes.

A customer “action,” as used herein, is any type of session, such as a transaction and/or interaction, involving both a customer 102 and firm 106. An action also may be termed an “action session.” The actions available to a customer may be determined by the type of business conducted by the firm. For example, the firm may conduct business over a computer network (e.g., the Internet), such as via one or more websites. Exemplary types of customer actions that may be performed over a computer network include registration, a visit (e.g., to a firm website), a download of one or more files, an upload of one or more files, an order and/or purchase of one or more goods and/or services, file viewing, sharing a file(s) (e.g., with another customer), or the like. Exemplary types of customer actions that may be performed by a customer physically present at the firm include registration, a purchase of one or more goods/services, a visit, a consultation, a trade, a return of one or more purchased goods/services, or the like.

A “non-contractual setting,” as used herein, is any business arrangement between a firm and customers in which each customer can become inactive at any selected time without notifying the firm and thus without observation by the firm. The term “churn” is used herein to denote silent attrition, namely, the unobservable event of a customer becoming inactive. In a non-contractual setting, the firm cannot know with certainty whether any given customer that has not performed an action for an extended period of time has actually churned or is just taking a long hiatus from doing business with the firm. The present disclosure provides a measure of the likelihood of customer action at a selected time point after a customer's most recent action and thus offers an indication of customer churn.

A “firm,” as used herein, is any person or organized group of people that offers goods and/or services to customers, generally for commercial purposes.

A “customer,” as used herein, is any person or organized group of people that performs actions, such as transactions and/or interactions, with a firm, generally for commercial purposes.

A customer “attribute,” as used herein, is any characteristic of customers. An attribute for an individual customer may be constant or may vary with respect to time and/or. customer action number. Exemplary attributes have values and/or may be assigned values for each customer, and may include age, gender, income, occupation, total number of actions, average time interval between actions, a time interval elapsed since the customer's most recent action, number of a particular type of action taken, etc. If the attribute varies over time, a value for the attribute for an individual customer may be determined, such as a value determined after an action has been taken by the customer. An attribute also may be termed a “covariate.”

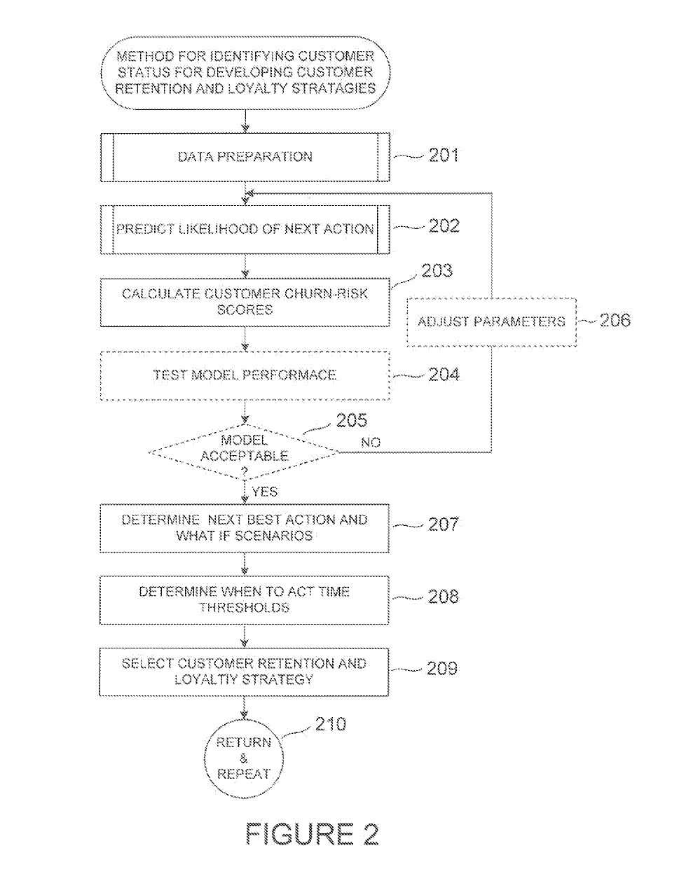

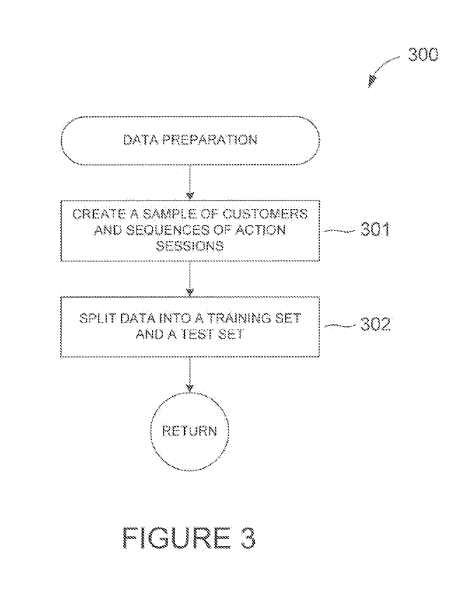

FIG. 2 shows a flowchart 200 illustrating steps in an example method for identifying customer status and for developing customer retention and customer loyalty programs. The steps listed in FIG. 2 are not limited to the order presented but instead may be performed in any suitable order and in any suitable combination, and may be combined with any other steps disclosed elsewhere herein. In step 201, a subroutine “data preparation” is called to organize customer data 110 and now described with reference to FIG. 3.

FIG. 3 shows a flowchart 300 illustrating steps that may be performed in an example method of preparing customer data referenced in step 201 of the flowchart 200. In step 301, a sample of customers and sequences of action sessions is created. First, customer data 110 is received. The customer data 110 may represent a plurality of actions taken by customers with respect to firm 106 in a non-contractual setting. The actions for each customer may be associated with a unique customer identifier, may be numbered sequentially, and time intervals between consecutive actions for the customer may be determined. The customer data may be a data sample prepared from a larger collection of customer data by selecting a sample of customers (e.g., a random sample, such as 0.01%) with the last observable date and a split date and the action data associated with each customer in the sample. For example, the last observable date can be Nov. 1, 2008 and the split date can be Nov. 1, 2007.

The customer data may also be processed in step 301. The action sessions may be organized as intervals with a beginning (from-date, from-action) and an ending (to-date, to-action). Action sessions for a customer where actions of the same type (e.g., uploading, ordering, sharing, etc.) occurred within a predefined length of time (e.g., 5, 10, or 30 minutes, among others) may be grouped as only one action session. For example, a customer may upload a set of files, one file at a time, and intuitively the uploading of these files should be grouped as the same action, that is, the same “upload session.”

In step 301, each action (or action session) for a customer may be assigned an action-session number, or “action number.” The action number may be an ordinal number that describes the relative temporal position of a particular customer action relative to the entire sequence of actions taken by the client. For example, as shown in FIG. 1, the initial action for each customer may be registration and may be assigned the number 0. Subsequent first, second, third, etc. actions by the same customer may be numbered, respectively, as 1, 2, 3, and so on. Also, a time interval between consecutive actions for a customer may be determined.

In step 302, the customer data is split into training and test data sets. The trailing data set is a collection of all the actions taken by the customers before the split date with the action dates as they were observed. After processing, a training data table may list, for each customer any combination of the following: customer identification number, from-action type (e.g., registration), from-action date/time, to-action type (e.g., upload), to-action date/time, duration time (time interval between from-action and to-action), values of attributes for the customer on or at the from-action date/time, and so on. For example, an attribute value may be the cumulative number of uploads from registration to the from-action (including the from-action).

The test data set is created from the same customer data set and can be composed of N artificial monthly intervals from the split date. After processing, the test data table may list any combination of the following: customer identification number, from-date, to-date, from-action, to-action, values of attributes assuming no additional observed customer actions after the split date, date of last action before the split date. The test data for computing the churn-risk-scores described below in step 203 of the flowchart 200 assumes prediction into the future from the split date or date of analysis, providing knowledge of any actions the customer may take in the future. The test data set for model performance testing described below in step 204 of the flowchart 200 includes the counts of the number of actions in the test data time horizon and intervals.

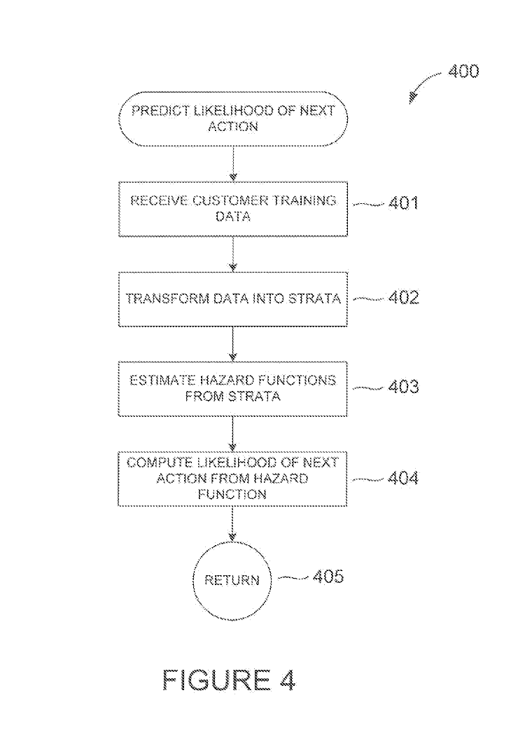

Returning to the flowchart 200 shown in FIG. 2, in step 202, a subroutine for predicting the likelihood of a next action by a customer is called and now described with reference to FIG. 4. FIG. 4 shows a flowchart 400 illustrating steps in an example method of evaluating a likelihood of next action by customers in a non-contractual setting. In step 401, the training data set created in step 302 of the flowchart 300 is received. in step 402, the training data may be transformed into stratified data composed of a plurality of strata. The strata may be defined according to the from-action and to-action numbers represented by each stratum. Each stratum may represent from-data and to-data for one for more) action number each. For example, observations of from-actions with action number 0 (registration) and to-actions with action number 1 (or no observable to-action with action number 1) for the customers may be grouped into a first stratum, such that the first stratum represents action number 0 and transitions (or no transition) to action number 1. As an illustration, stratum 1 may represent observations of all customers in the sample where the from-action is registration (action number 0) and the to-action is the first action (action number 1) after registration (e.g., upload, order, share, etc.) or is marked as “EOD” (“end of data,” which is a flag to identify a censored observation if the customer did not take an observable first action after registration). Similarly, stratum 2 may be composed of observations across all customers in the sample where the from-action is action number 1 and the to-action is action number 2 or EOD (for customers that took a first action hut not a second action). Some or all of the strata may group action numbers (i.e., may represent from-actions and to-actions for more than one action number each), which may help to accommodate the long tail of the action number distribution produced by individual customers with a large number of actions. For example, stratum 3 may be composed of observations from action number 2 to action number 3, and from action number 3 to action number 4.

In step 403, hazard functions may be estimated from the strata. A “hazard function,” as used herein, is a probability measure that a customer will have a next action at a given time after a previous action, conditional on the occurrence of the previous action. The hazard function may be based on a Cox conditional proportional hazard model for multiple events (also termed “the Model”). The Model provides a statistical model in which a baseline hazard probability is resealed by one or more covariates. The hazard probability may respond exponentially to changes in the value of each covariate. The Model may be semi-parametric, with the hazard baseline function determined as an empirical probability distribution. Alternatively, the Model may be parametric, with the hazard baseline function specified by a theoretical probability distribution.

The Model may be exploited to incorporate the impact of time from the latest action (the “previous action”) and the values of customer attributes along with their weights. The Model may estimate the conditional probability of a next action at a time t after the previous action. The outcome of the Model for each stratum may be a set of one or more weights for respective corresponding customer attributes and baseline hazard rates at different time points from the previous action (i.e., the time at which the previous action was taken by a customer is time zero). Generally, a distinct hazard function may be estimated for each stratum j with the form

hⱼ(t)=h₀ⱼ(t)exp (βⱼxⱼ)

where h₀ⱼ(t) is the baseline hazard function with respect to time t from the latest customer action (if represented by the stratum), and where βⱼ represents an attribute weight for the stratum j and is multiplied by a corresponding customer attribute xⱼ for the attribute weight. The attribute may have a customer-specific value defined at the time the stratum data occurred, such as when a customer performed the previous action. Any number of attribute weights and corresponding attributes may be included in the hazard function. Here, is shown explicitly, but in other examples, two, three, or more weights and corresponding attributes may be utilized. In other words, the baseline hazard function may be scaled using one or more weight values multiplied by their corresponding customer attribute values. Weights may be estimated separately for each stratum. The weights may be estimated using a maximum likelihood method, which may utilize both the uncensored data (from-action and to-action in stratum) and the censored data (EOD; from-action but not to-action in stratum).

In step 404, a likelihood of a next action may be calculated from a hazard function for a stratum. The likelihood may be calculated with a computer and may provide a likelihood of next action at one or more different time points from the latest action taken by individual customers whose latest action has an action number represented by the stratum. The calculation for an individual customer may be performed by selecting a time value (for a time interval beginning at the customer's latest action), obtaining values for weights of the stratum, determining values for attributes of the customer corresponding to each of the weights at the time the customer completed the latest action), and placing the values into the hazard function to compute a likelihood of next action. In some embodiments, the likelihood of next action may be operated on to provide a probability that expresses a churn-risk score described below in step 203 of the flowchart 200.

In step 405, the method of predicting the likelihood of next action returns to the method of flowchart 200 shown in FIG. 2.

Returning to FIG. 2, in step 203, customer churn-risk score is computed for each customer. This step enables evaluation of customer status and, if the customer is alive, determines the customer's risk of churning over a given time period. In other words, the firm can analyze the current status of the customers to determine a customer's churn-risk score, enabling the firm to determine what fraction of customers have likely already churned, what fraction of customers have a high probability of churning, and what fraction of customers are most active customers. The firm can also segment the customers using attribute values, as well as, by churn-risk score to analyze the status of business relevant segments.

The churn-risk scores enable the selection of particular customer retention and loyalty strategies to be applied at different levels of customer aggregation. For example, customers with churn-risk scores that fall within a certain range, such as 0.80 to 0.99, may indicate that specifically targeted customer retention and loyalty strategies have to be applied to prevent these customers from churning. Different strategies, such as less aggressive stategies, can be applied to groups of customers with churn-risk scores that fall within a different range, and other strategies can be applied to the whole customer base. The ability to compute churn likelihood at the individual customer level allows for one-on-one targeting of messages, such as sending e-mail messages or letters that make specific offers directed to catching the attention of individual customers as part of the retention and loyalty strategy.

A customer churn-risk score is the probability of no action for a period of time, such as 6 months or 1 year, from the last observed action date of the customer, conditional on the last action number of the customer. In particular, the churn-risk score can be computed using a computing device for each customer based on the customer's last action date, last action number for assigning the customer to a particular stratum, s, weights of the attributes from the stratum s, and values of the attributes on the last action date. The method of computing the churn-risk score allows for computing the churn-risk scores for different suitable churn time horizons, which can be defined by the user. For example, a churn time horizon can be 6 months, 1 year, 2 years, or even 3 or more years as defined by the user. The method also allows for computing the churn-risk scores for different time periods into the future from the date of analysis, such as 6 months or 1 year.

The method for computing a customer churn-risk score allows for time varying attributes. Customer attributes may include gender, age, income, and health just to name a few. Over time, certain attributes, such as age, income, and health can change. For example, a customer's age continues to increase with tune, income may increase or decrease, and a customer's health may deteriorate with time. Thus, methods of the present invention account for time varying attributes, which can be accomplished by breaking the time period into smaller time intervals and computing a conditional survival probability of surviving until the end of the interval conditional on having survived until the beginning of the interval. In certain embodiments, the churn-risk of a customer is given by the survival probability:

P(S>t|x(t₁))

where x(t₁) represents the time dependent attributes of the customer at time t₁. Assuming that additional attributes are know at later times t₁, 1₂, . . . , t_{J}, where t₁<t₂< . . . <t_{J}, and predicting the risks at all of these times to be r₁, r₂, . . . , r_{J}, respectively, the survival probability, or churn-risk score, becomes:

$$P ( S > t \vert x ( {t}_{1} ) ) = P ( S > {t}_{1} \vert x ( {t}_{1} ) ) \times {\prod }_{j = 2}^{J} P ( S > {t}_{j} \vert S > {t}_{j - 1} , x ( {t}_{j - 1} ) ) \times P ( S > t \vert S > {t}_{J} , x ( {t}_{J} ) )$$

where tⱼ is the largest time for which time varying attributes are known and tⱼ≦t.

The method presented in flowchart 200 also includes an optional step 204. In optional step 204, the test data set generated in step 302 of the flowchart 300 is used to test the Model's performance. In other words, in step 204, the performance of the methods carried out in steps 202 and 203 are tested. For example, for a given customer on the date of analysis, such as the last observation date, the probability that the customer will have no action for a period of time t can be computed using the conditional probability:

P(S>y₀+t|S>y₀)

where y₀ is the time from the date of the last action to the date of analysis. The conditional probability can be calculated for different values of t. For example, time t can be 1 day to 1 month to 3 months, or 1 year to 3 years. The actual time from the date of analysis to the next action can also be computed, if the actual time has been observed. In step 204, actual and predicted rates of inactivity can be computed in the period of time t from the date of analysis and can be computed at different levels of aggregation for individual customers, customer segments or groups, and the whole customer base level.

Step 204 also allows for the creation of a feedback loop, in step 205, in order to tune and improve the methods of steps 202 and 203. In step 205, when the Model is deemed acceptable, the method proceeds to step 207. Otherwise, when the output of the Model is deemed unacceptable, the method proceeds to step 206. in step 206, parameters, such as weights and attributes can be adjusted by the user and steps 202-204 can be repeated.

In step 207, what-if-scenarios can be created to identify the action, called the “next-best-action,” taken by the firm to reduce a customer's churn-risk score, or probability of churning. What-if-scenarios are created by comparing a customer's churn-risk score with the same customer's churn-risk score under different hypothetical scenarios, which can be accomplished as follows. For each customer, a hypothetical churn-risk score is computed as if the customer had performed an action of a certain type on a particular day, such as the date of analysis. Next, what if scenarios are created and performed at different times in the future for combinations of actions and can incorporate the likelihood, or probability, of the customer taking a certain type of action based on the results obtained in step 202. What-if-scenarios can be performed at different levels of aggregation ranging from individual customers, to groups of customers, to the whole customer data base. For example, a churn-risk score computed for an action taken on the date of analysis is compared with the customer churn-risk scores for different hypothetical actions taken at later dates.

In determining what-if-scenarios, the data preparation described above in step 201 is modified to create a data set where a hypothetical action of a certain type performed on a certain date is added to the customer data base and attribute values that depend on the hypothetical action are updated to reflect the change. Steps 201-203 are repeated to create a new churn-risk score for the same customer as if the customer had performed the hypothetical action on the date of analysis. A user can define the date of analysis as well as other aspects of steps 201-203. For example, a hypothetical upload action taken on the date of analysis by a customer changes the customer's data in the customer data base because the number of uploads since registration has increased by 1 and the time since last upload decreases to 0.

In step 208, when-to-act time thresholds are computed in order to identify when, from the date of analysis, a non-high risk customer of churning will become a high-risk customer of churning at sonic later time. The when-to-act time threshold is the time from the date of analysis when the customer's churn-risk score is greater than a churn-risk threshold defined by the user. The time threshold can be used to trigger active retention and loyalty strategies for the customer. A churn-horizon time, t*, defined as the length of time over which an inactive customer is considered to have churned is defined by the use is used in the calculation of the time thresholds. For example, the churn-horizon time can be 6 months or 1 year. Suppose a user sets the churn-risk threshold at 0.95. The when-to-act time threshold, t(s), for a particular customer segment s can be defined as:

P(S>t*|S>t(s),s)=0.95

or equivalently by:

$$P ( S > t ( s ) \vert s ) = ( \frac{1}{0.95} ) P ( S > {t}^{*} \vert s )$$

In other words, the probability of the customer segment s churning after the when-to-act time threshold has passed is equal to the probability of the customer segment s churning after the churn-horizon time has passed.

In step 209, retention and loyalty strategies are selected. What-if-scenarios help define and execute one or more, called “call-to-action strategies” as part of the customer retention and loyalty strategy. What-if-scenarios can be used to decide a retention strategy and communication strategy that places greater incentives for a customer to take the next-best-action from a set of several possible actions. The firm can select one or more retention and loyalty strategies at an individual customer level, group level, or whole customer base level on what the next-best-action to use in carrying out the retention and loyalty strategy.

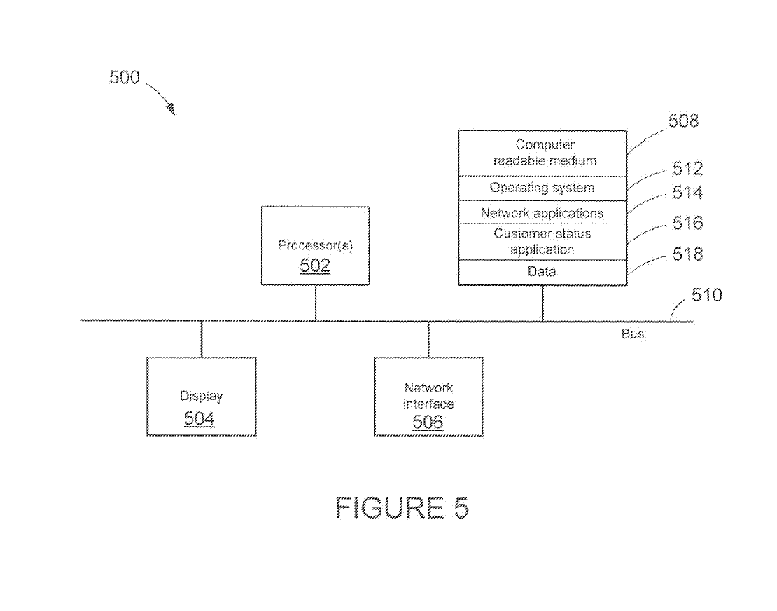

In general, methods of the present invention can be implemented on a computing device, such as a desktop computer, a laptop, or any other suitable device configured to carrying out the processing steps of a computer program. FIG. 5 shows a schematic representation of a computing device 500 configured in accordance with embodiments of the present invention. The device 500 may include one or more processors 502, such as a central processing unit; one or more display devices 504, such as a monitor; one or more network interfaces 506, such as a Local Area Network LAN, a wireless 802.11x LAN, a 3G mobile WAN or a WiMax WAN; and one or more computer-readable mediums 508. Each of these components is operatively coupled to one or more buses 510. For example, the bus 510 can be an EISA, a PCI, a USE, a FireWire, a NuBus, or a PDS.

The computer readable medium 508 can be any suitable article, or medium, that participates in providing instructions to the processor 502 for execution. For example, the computer readable medium 508 can be non-volatile media, such as firmware, an optical disk, a magnetic disk, or a magnetic disk drive; volatile media, such as memory; and transmission media, such as coaxial cables, copper wire, and fiber optics. The computer readable medium 508 can also store other software applications, including word processors, browsers, email, Instant Messaging, media players, and telephony software.

The computer-readable medium 508 may also store an operating system 512, such as Mac OS, MS Windows, Unix, or Linux; network applications 514; and a document layout application 518 that performs the methods of the present invention. The operating system 512 can be multi-user, multiprocessing, multitasking, multithreading, real-time and the like. The operating system 512 can also perform basic tasks such as recognizing input from input devices, such as a keyboard, a keypad, or a mouse; sending output to the display 504; keeping track of files and directories on medium 510; controlling peripheral devices, such as disk drives, printers, image capture device; and managing traffic on the one or more buses 510. The network applications 514 include various components for establishing and maintaining network connections, such as software for implementing communication protocols including TCP/IP, HTTP, Ethernet, USB, and FireWire.

The computer readable medium 508 can also store a customer status application 516 that provides various software components for operating on the data 518 and automatically carrying out the methods described above with reference to FIGS. 2-4, as described above. The data 518 may include customer data, including customer identifications that uniquely identify each customer and permit all customer-specific data for each individual customer to be linked to one or more actions, action numbers, and times when actions occurred just to name a few. The data 518 may also include customer attributes that are linked to the customer identification, stratified data, test data sets, and training data sets described above. In certain embodiments, some or all of the processes performed by the application 514 can be integrated into the operating system 512. In certain embodiments, the processes can be at least partially implemented in digital electronic circuitry, or in computer hardware, firmware, software, or in any combination thereof.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise foams disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method of identifying customer status for developing customer retention and loyalty strategies using a computing device, the method comprising:
calculating (202) likelihood of next action taken by customers based on customer attributes and associated attribute weights stored in a customer data base;
calculating (203) customer churn-risk scores based on customer attributes that vary over time using the computing device;
determining (207) what-if-scenarios for each customer based on churn-risk scores in order to identify the next-best-action to reduce probability of customer churn;
determining (208) when-to-act time thresholds for each customer based on churn-risk scores in order to identify when a non-high risk customer of churning will likely become a high-risk customer of churning at some later time; and
selecting (209) customer retention and loyalty strategies for customers based on the churn-risk scores, what-if-scenarios, and when-to-act time thresholds.

2. The method of claim 1 further comprising preparing (201) customer data representing a number of actions taken by individual customers and customer attributes.

3. The method of claim 2, wherein preparing the customer data further comprises splitting the customer data into a training data set and test data set.

4. The method of claim 1 further comprising:
comparing (204) likelihood of next action and churn-risk scores to likelihood of next action and churn-risk scores of a test data set of the customer data base; and
adjusting (206) parameters and repeating the steps of predicting likelihood of next action and computing customer churn-risk scores, when the method of claim 1 produces unacceptable results.

5. The method of claim 1, wherein calculating (203) customer churn-risk scores further comprises calculating for each customer a churn-risk score based on the customer's last action date, last action number for assigning the customer to a particular stratum, s, weights of the attributes from the stratum s, and values of the attributes on the last action date.

6. The method of claim 1, wherein the customer churn-risk score further comprises the probability of no action taken by the customer for a period of time.

7. The method of claim 1, wherein the determining (207) what-if-scenarios for each customer further comprises creating a data set within the customer data where for each customer a hypothetical action of a certain type performed on a certain date is added to the customer data base and attribute values that depend on the hypothetical action are updated to reflect the change.

8. The method of claim 1, wherein determining (207) what-if-scenarios for each customer further comprises:
for each customer, computing a hypothetical churn-risk score as if the customer had performed an action of a certain type on a particular day; and
creating what-if-scenarios performed at different times in the future for combinations of actions based on the likelihood of the customer taking a certain type of action.

9. The method of claim 1, wherein determining (208) the when-to-act time thresholds further comprise computing when, from a date of analysis, a non-high risk customer of churning will likely become a high-risk customer of churning at some later time.

10. The method of claim 1, wherein determining (208) the when-to-act time thresholds further comprises determining the time from the date of analysis when the customer's churn-risk score is greater than a churn-risk threshold.

11. An article comprising at least one computer readable medium having instructions executable by a computing device to perform a method of identifying customer status for developing customer retention and loyalty strategies, the method comprising:
calculating (202) likelihood of next action taken by customers based on customer attributes and associated attribute weights stored in a customer data base;
calculating (203) customer churn-risk scores based on customer attributes vary over time using the computing device;
determining (207) what-if-scenarios for each customer based on churn-risk scores in order to identify the next-best-action to reduce probability of customer churn;
determining (208) when-to-act time thresholds for each customer based on churn-risk scores in order to identify when a non-high risk customer of churning will likely become a high-risk customer of churning at some later time; and
selecting (209) customer retention and loyalty strategies for customers, based on the churn-risk scores, what-if-scenarios and when-to-act time thresholds.

12. The article of claim 1 further comprising preparing (201) customer data representing a number of actions taken by individual customers and customer attributes.

13. The article of claim 1, wherein calculating (203) customer churn-risk scores further comprises calculating for each customer a churn-risk score based on the customer's last action date, last action number for assigning the customer to a particular stratum, s, weights of the attributes from the stratum s, and values of the attributes on the last action date.

14. The article of claim 1, wherein determining (207) what-if-scenarios for each customer further comprises:
for each customer, computing a hypothetical churn-risk score as if the customer had performed an action of a certain type on a particular day; and
creating what-if-scenarios performed at different times in the future for combinations of actions based on the likelihood of the customer taking a certain type of action.

15. The article of claim 1, wherein determining (208) the when-to-act time thresholds further comprises determining the time from the date of analysis when the customer's churn-risk score is greater than a churn-risk threshold.
